(19) United States
(12) Patent Application Publication
(10) Pub. No.: US 2005/0154841 A1
(43) Pub. Date: Jul. 14, 2005

(54) Data storage system for a multi-client network and method of managing such system

(76) Inventors: Gautham Sastri, Montreal (CA); Lain B. Findleton, Baie D'Urfe (CA); Steeve McCauley, Montreal (CA); Ashutosh Rajekar, Montreal (CA); Ariel Rosenblatt, Montreal (CA); Xinliang Zhou, Montreal (CA); Yue Xu, Montreal (CA)

Correspondence Address: SEYFARTH SHAW, 55 EAST MONROE STREET, SUITE 4200, CHICAGO, IL, 60603-5803, US

(21) Appl. No.: 11/073,953

(22) Filed: Mar. 7, 2005

Related U.S. Application Data
(63) Continuation of application No. 10/159,685, filed on May 31, 2002, now abandoned.
Application No. 10/159,685 is a continuation of application No. 10/135,421, filed on Apr. 30, 2002, now abandoned.
(60) Provisional application No. 60/289,129, filed on May 8, 2001.

(51) Int. Cl. G06F 12/00

(52) U.S. Cl. 711/148

(57) ABSTRACT

The data storage system comprises a scalable number of routing processors (RPs) through which clients of a network communicate. The storage system also includes a scalable number of storage processors (SPs) connected to a scalable number of storage units (SUs). This data storage system provides a new and hybrid approach which lies in between conventional NAS and SAN environments. It creates a unified and scalable storage pool accessible through a single consistent directory without the need for a metadata controller (MDC). There is thus no table lookup at a central node and no single point of failure. It allows a dissociation of the relationship between the physical path and the actual location where the data objects are stored.

### CROSS-REFERENCE TO RELATED APPLICATION

This is a continuation of U.S. patent application Ser. No. 10/135,421 filed Apr. 30, 2002 which claims the benefit of U.S. provisional patent application No. 60/289,129 filed May 8, 2001.

### BACKGROUND

The centralization of digital data sharing for a multi-client environment was traditionally implemented solely through what became known as servers. Briefly stated, a server is a piece or a collection of pieces of computer hardware that allows multiple clients to access and act upon or process data stored therein. Data is accessed by sending an appropriate request to the server, which in turn resolves the request, gets the requested data from a storage pool and delivers it to the client who made the request. Serving up data is only one of the tasks of a server, which fulfills both the tasks of serving and processing data. A very busy server thus has a higher latency rate than a server having less ongoing tasks.

A storage pool generically refers to a location or locations where a collection of data is stored. As in all cases, data must be stored in an organized fashion and to this end, a file system is provided to facilitate storing and retrieving data. There are many different file systems on the market, most, if not all, of which are hierarchical by nature, relying on a tree-type scheme to categorize and sort the pieces of data. These pieces of data are generically referred to as “data objects” hereafter. A data object can be a file or a part of a file. Furthermore, clients or external clients, either referring to persons, their computers or software applications therein, are generically referred to as “clients” hereafter.

A key capability of all file systems is the file locking. A locking scheme is used to ensure that only one client can be writing to a given data object at any given instant in time. This ensures that several clients cannot save different versions of a data object at the same time, otherwise only the changes made by the last client to save the data object would be retained.

As aforesaid, storage pools were traditionally captive to servers. Because this centralized data model has some drawbacks and limitations, a new approach was introduced roughly in the late Nineties. It involves; a technology that is commonly referred to as Network Attached Storage (NAS), where autonomous devices are connected to a network where they are needed in order to remove work from general-purpose servers and their conventional storage devices. This allows to free up the servers so they can deal with applications and other data-processing tasks. Sometimes called toasters or NAS appliances, NAS devices require much less programming and maintenance than general-purpose servers and their conventional storage systems.

FIG. 1 shows a schematic example of a network (10) to which is attached a NAS device. The NAS device typically comprises a storage processor (SP) and a storage unit (SU) provided in a single box. NAS devices offer improved performance over general-purpose servers for the specific job of serving data objects as they are dedicated to this specific task, carrying a lot less overhead. Ultimately, clients (12) benefit from the new network infrastructure because data objects are processed faster.

While NAS devices do indeed offer many advantages, they unfortunately have the inability to scale in either bandwidth or capacity. Thus, once the maximum capacity of a NAS device has been reached, for instance when the number of clients rises to the point where they cannot be served in a timely fashion or when a NAS device is simply running out of disk space, additional NAS device(s) will need to be added to the network in order to increase the overall storage capacity. However, there will be no correlation between the old NAS device and the new one(s). Data objects will eventually need to migrate from the old NAS device to the new NAS device(s) and be synchronized if the transition needs to be achieved without interruption.

Another known approach is the Storage Area Network (SAN) model. The SAN model typically comprises the use of a small network whose primary purpose is to transfer data, at extremely high rates, between external computer systems and SUs. A SAN system consists essentially of a communication infrastructure that provides physical connections, storage elements and computer systems. SAN-based data transfers are also inherently secure and robust. SAN systems are different from NAS devices in that the storage unit or units are decoupled from the clients. Any data is accessed through metadata controller (MDC), which is itself interconnected to one or more SUs. If more than one SU is present, the MDC is typically connected to the SUs by means of a fiberchannel switch or a similar device. The MDC exposes the contents of the SAN system and also handles the global file locking, thereby preventing multiple clients from writing or updating the same data object at the same time.

FIG. 2 is a schematic view of one example of a SAN system. It should be noted that a multitude of other embodiments are possible as well.

Unlike NAS devices, the capacity of a SAN system is highly scalable since more SUs can be added. However, with a SAN environment, a single file system is maintained for all the stored data. Clients also communicate with the SUs only through the MDC. Therefore, an important disadvantage is that the MDC can become a bottleneck since all requests for data objects are transmitted through a single point. Although more than one MDC can be present in a SAN system, using multiple MDC involves a much higher level of complexity since the MDCs would have to constantly communicate between themselves.

### SUMMARY

The present invention provides a new and hybrid approach that somehow lies in between the NAS devices and SAN systems. This data storage system and corresponding method have several important advantages over the ones previously described in the background section. This data storage system has an infrastructure, which allows to create a unified and scalable storage pool accessible through a single consistent directory without the need for a metadata controller (MDC). It allows to dissociate the relationship between the physical path and the actual location where the data objects are stored. The contents of the data storage system are exposed to clients of the network as a single name entry. This allows to create one single virtual file system from any combination of local or remote storage resources and networking environments, including legacy storage devices.

Objects, features and other advantages of the present invention will be more readily apparent from the following detailed description of possible and preferred embodiments thereof, which proceeds with reference to the accompanying figures.

### BRIEF DESCRIPTION OF THE FIGURES

FIG. 1 is a schematic view illustrating an example of a Network Attached Storage (NAS) as found in the prior art.

FIG. 2 is a schematic view illustrating an example of a Storage Area Network (SAN) as found in the prior art.

FIG. 3 is a schematic view illustrating an example of a data storage system in accordance with a possible and preferred embodiment of the present invention.

FIG. 4 is a schematic view of a control network used with the data storage system of FIG. 3.

FIG. 5 is a schematic view illustrating an example of a data storage system in accordance with another possible embodiment of the present invention.

FIG. 6 is a schematic view illustrating an example of a data storage system in accordance with another possible embodiment of the present invention.

FIG. 7 schematically shows an example of logical containers within a storage unit (SU).

FIG. 8 is a view similar to FIG. 7, showing an example of a logical container overlapping two storage units (SUs).

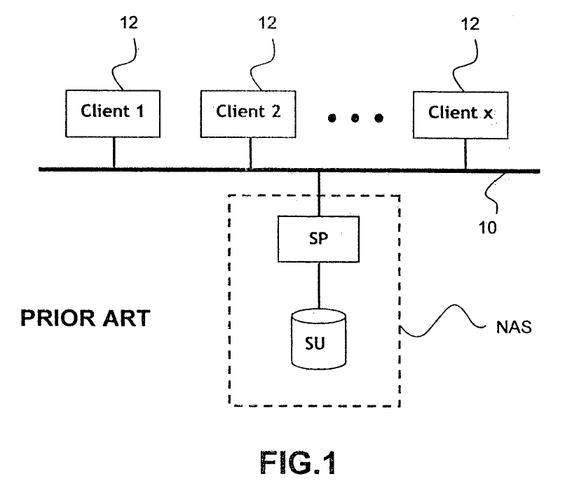

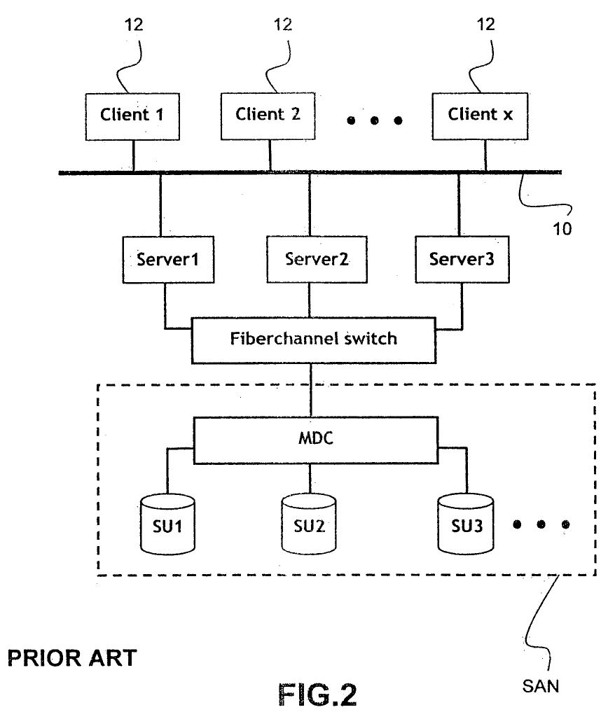

### Acronyms and Reference Numerals

The detailed description refers to the following technical acronyms:
API Application program interface
CDBD Configuration database daemon
CIFS Common Internet file system
CRC Cyclic redundancy check
DHCP Dynamic host configuration protocol
DNS Domain name server
FTP File transfer protocol
GPL General public license
GUI Graphical user interface
IP Internet protocol
I/O Input/output
LAN Local-area network
MDC Metadata controller
MS Management station
NAS Network attached storage
NFS Network file system
NMP Node management protocol
NVM Non-volatile memory
PERL Practical Extraction and Report Language
RAM Random-access memory
RP Routing processor
SAN Storage area network
SCP Secure copy
SP Storage processor
SU Storage unit
TCP/IP Transmission control protocol/internet protocol
VPN Virtual private network
WAN Wide-area network
XML Extensible markup language

The following is a list of reference numerals, along with the names of the corresponding components, which are used in the detailed description and in the accompanying figures:
10 Network
12 Clients
20 Storage system
30 Routing processors (RPs)
40 Storage processors (SPs)
50 High-speed router
52 Fiberchannel switch
60 Storage units (SUs)
70 Management station (MS)
72 Control network
74 Ethernet switch

### DETAILED DESCRIPTION

Overview

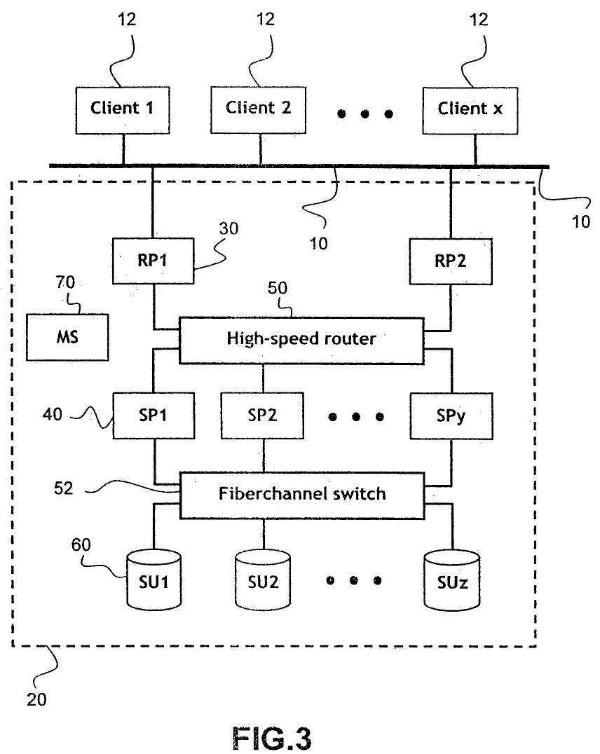

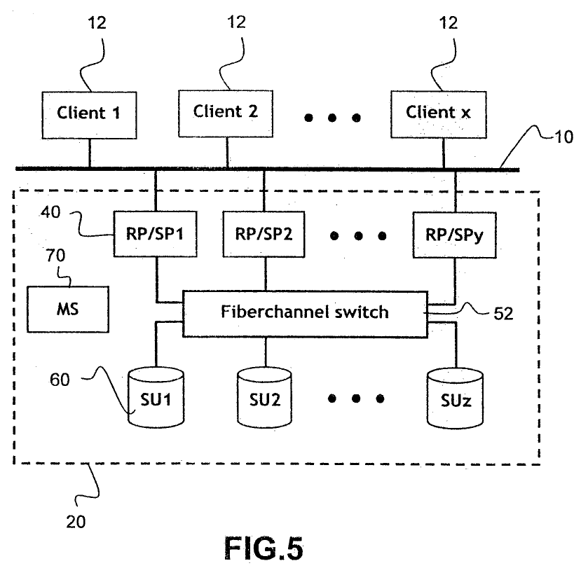

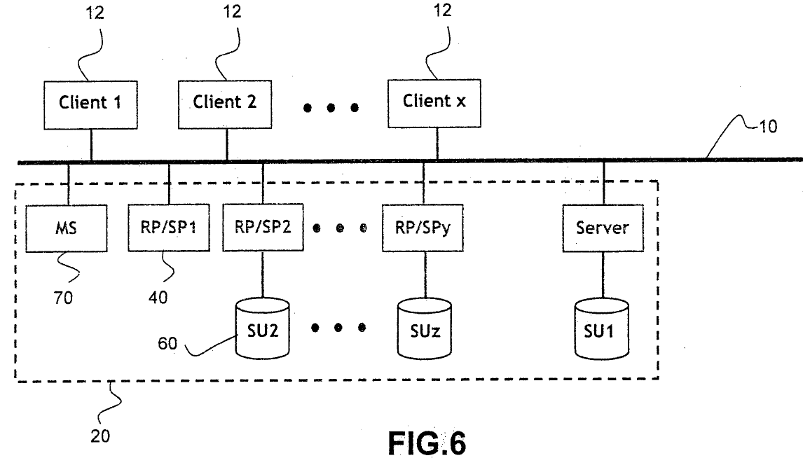

A data storage system (20) according to a possible and preferred embodiment of the present invention is described hereafter and illustrated in FIG. 3. There are however several other possible embodiments thereof, two of which are illustrated in FIGS. 5 and 6. It is to be understood that the invention is not limited to these embodiments and that various changes and modifications may be effected therein without departing from the scope or spirit of the present invention.

In FIGS. 3, 5 and 6, the data storage system (20) is interconnected to the clients (12) by means of a data network (10). Depending on the implementations, the network (10) can be, for instance, a Local-Area Network (LAN), a Wide-Area Network (WAN) or a public network such as the Internet. In the case of a WAN or a public network, the components of the data storage system (20) can be scattered over a plurality of continents.

Preferably, the network (10) is an IP-based network and clients (12) communicate with the data storage system (20) using, for instance, one or more Gigabit Ethernet links (not shown) and a standard networking protocol, such as TCP/IP. In this latter case, the data storage system (20) may be configured to support services such as File Transfer Protocol (FTP), Network File System (NFS), Common Internet File System (CIFS) and Secure Copy (SCP), as needed. Other kinds of networks, protocols and services can be used as well, including proprietary ones. Furthermore, if the network (10) includes an access to the Internet or another public network, a Virtual Private Network (VPN) can be implemented for securing the communications between clients (12) and the RPs (30). For even more secure implementations, the various constituents of the data storage system (20) can be set locally as in FIGS. 3 and 5.

The data storage system (20) comprises a collection of hardware and software components. The hardware components include a scalable number of RPs (30), for instance those identified as RP1 and RP2 in FIG. 3. The RPs (30) are the ones to which clients (12) send their operation request to access or store data objects in the storage pool of the data storage system (20). There is thus at least one RP (30) in each storage system (20). The number of RPs (30) depends essentially on the number of clients (12) and also on the desired level of robustness of the data storage system (20). In the case of multiple RPs (30), the exact RP (30) to which a given client (12) connects could be resolved by a DNS call. Additional RPs (30) also allow alternative connection points for clients (12) in case of a failure or a high latency at their default RP (30).

The data storage system (20) also includes a scalable number of storage processors (40), for instance those identified as SP1 and SP2 in FIG. 3. Although one SP (40) would provide some functionality, there is usually a plurality of SPs (40) in each data storage system (20). In the embodiment of FIG. 3, each of the SPs (40) is connected to the RPs (30) by means of a high-speed router (50).

The data storage system (20) further includes a scalable number of storage units (60), for instance those identified as SU1 and SU2 in FIG. 3, which collectively form the storage pool where are stored the data objects. Each SU (60) includes a storage media, for example one or an array of physical disk drives, CDs, solid-state disks, tape backups, etc. The storage media may include almost any kind of storage device, including memory chips, for example Random-access memory (RAM) chips or Non-volatile memory (NVM) chips, such as Flash, depending on the implementations. Another example of a possible storage media is an archive device comprising an array of tape devices that are automounted by robots.

In the embodiments of FIGS. 3 and 5, the SPs (40) and the SUs (60) are interconnected by a fiberchannel interconnect, more preferably a fiberchannel switch (52). Other kinds of interconnection devices can be used as well, depending on the implementations. The fiberchannel switch (52) allows each SP (40) to have the capability of communicating with anyone of the SUs (60) at a very high-speed. It should be noted that fiberchannel switches and other kinds of interconnection devices are well known in the art and do not need to be further described. SUs (60) can be any type of device that preferably supports an interface through a Linux VFS layer.

In FIG. 5, the RPs (30) and the SPs (40) are combined in a single node. More specifically, one node combines the function of a RP (30) and a SP (40). It should be noted that another possible embodiment is to have both independent RPs (30) and SPs (40), together with some nodes having a combined RP/SP, within the same data storage system (20).

FIG. 6 illustrates a further possible embodiment of the data storage system (20). In this embodiment, the high-speed router and the fiberchannel switch of FIG. 3 are replaced by general connections to the network (10). Each device has a specific address within the network (10) and is connected to, for instance, Ethernet links (not shown). This data storage system (20) works essentially the same way as with the other embodiments. Furthermore, FIG. 6 illustrates the fact that SUs (60) can be connected elsewhere in the data storage system (20) that to SPs (40). For instance, SU1 is connected to a general-purpose server that may be part of a legacy storage system.

Logical Containers

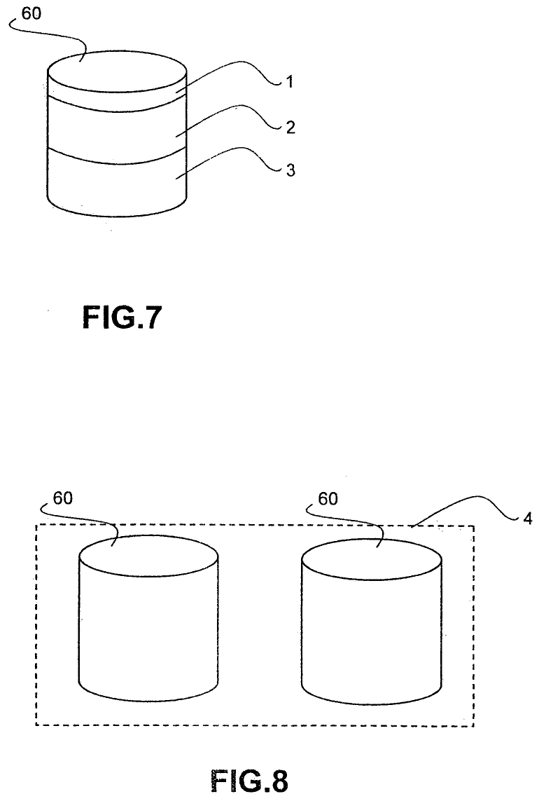

For each implementation of the data storage system (20), a predetermined number (n) of logical containers is provided when the data storage system (20) is initially configured. A logical container is defined as a logical partition of the storage pool. One or more logical containers can be assigned to each SU (60), as schematically illustrated in FIG. 7. In the example, the SU (60) is configured to have three logical containers, namely containers 1, 2 and 3. A logical container can also span over two or more SUs (60), or part thereof, as schematically illustrated in FIG. 8. In the example, container 4 overlaps two SUs (60). The logical containers are not necessarily equal in size but are not overlapping each other, each logical container corresponding to specific blocks within the storage pool. Any portion of the storage pool preferably has a corresponding logical container. However, depending on the implementation, one can leave a portion out of the storage pool for future use or for another reason. Portions of the storage pool that do not have a corresponding logical container would not be directly accessible by the data storage system (20).

When the data storage system (20) is in operation, the assignation of the logical container may be changed, although their number cannot change. The re-assignation of the logical containers is carried out through a Managing station (MS), referred to with the reference numeral 70. The MS (70) is explained in more details hereafter. The re-assignation may be necessary, for instance, if the number of the SUs (60) increases or if the capacity of one or more SUs (60) is increased. Other reasons may also call for the re-assignation of one or more logical containers, for instance for load balancing. Yet, logical containers may use any type of vendor specific file system implemented on a process or platform that supports a UNIX®, Windows®, Linux or any other type of operating systems, as needed.

Preferably, the number (n) of logical containers is in accordance with a factor of 2. For example, a data storage system (20) may comprise 64 containers (n=2⁶). A larger implementation of the data storage system (20) may, for instance, comprise 1024 containers (n=2¹⁰). A positive integer number, for instance container 0 through container 1023, then advantageously labels these logical containers. This number will be used by the data storage system (20) to know where a data object is to be stored or where it is stored. The number (n) of logical containers will not change once a data storage system (20) goes into service unless it is completely reinitiated.

Each container is managed by one SP (40). A same SP (40) can manage more than one logical container. However, one logical container cannot be managed by more than one SP (40) at the same time. The number (y) of SPs (40) is thus equal or less the number (n) of logical containers. Nevertheless, specific implementations may require having additional SPs (40) to replace one or more SPs (40) if a failure occurs. Accordingly, the number (y) of the SPs (40) could be greater than the number (n) of logical containers, depending on the exact configuration.

As aforesaid, it is important to note that although the number (n) of logical containers is fixed, the capacity of the data storage pool remains almost infinitely scalable. Since the logical containers are only logical partitions, they can thus be reassigned easily. A SP (40) can also be added if the number (y) of SPs (40) is below the predetermined number (n) of logical containers. More disks or memory can also be added at a given SU (60).

Previous experiments have indicated that a ratio of up to 4 SPs (40) per RP (30) delivers an optimum throughput performance. Improvements in the performance of disks, file systems and interconnection media may reduce the ratio of SPs (40) to RPs (30) down to 2 or 3. Of course, other ratios can be used as well, depending on the implementations.

Management Station (MS)

The MS (70) is a special node that contains a master configuration database. The main purpose of the MS (70) is to keep the configuration database up to date. The MS (70) preferably communicates with the RPs (30) and the SPs (40) using a dedicated protocol referred to hereafter as the Network Management Protocol (NMP). A NMP daemon is also provided at the RPs (30) and the SPs (40) for handling the NMP messages. The payload for the messages is preferably the XML format data specific to the individual functions. The NMP ensures that only a minimum of information is sent and that configuration changes occur almost instantly.

The NMP comprises a series of inter-processor messages to implement automatic procedures that support initialization, configuration, system management, error detection, error diagnosis and recovery, and performance monitor. The NMP provides services which are preferably based on the use of standard remote procedure call interface to execute appropriate commands residing in a supporting script library. The NMP script library implements the specific functionality of each of the NMP messages. The scripts are preferably implemented using the PERL programming language. A separate library for the MS (70) and each of the RPs (30) and SPs (40) implements the functionality specific to each of these components.

The MS (70) may also allow to control the version of the applications running at the RPs (30) and the SPs (40). If a more current version is available, it may force the RPs (30) and the SPs (40) to update. Updates can be implemented using, for instance, an HTTP-based distribution service supported by a script library at the MS (70). Other methods can be used as well. The MS (70) may further provide a diagnosis and maintenance module to detect, isolate, identify and repair error conditions on the data storage system (20). It may also be used to monitor performance statistics. Finally, the MS (70) may implement other useful features such as automated backup and encryption.

The MS (70) can be in the form of a standard desktop machine running, for example, the Linux operating system. The MS (70) can also be included on a node carrying out other tasks in the data storage system (20), for instance a RP (30). Yet, the MS (70) preferably comprises a factory installed confirmation database. An operator or user of the MS (70) has access to the database with a GUI implemented through scripts driven from a Web based interface. This interface preferably allows to reconfigure any node in the data storage system (20), adjust the network topology and access performance and fault statistics. The user or operator may also have access to a number of user configurable options.

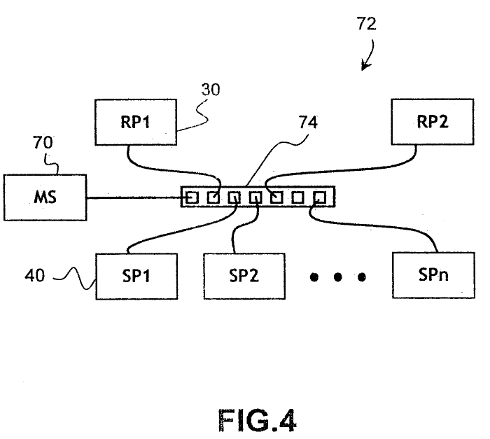

As shown in FIG. 4, the MS (70) is preferably interconnected to the RPs (30) and the SPs (40) of the data storage system (20) through an independent control network (72). The control network (72) comprises preferably an Ethernet switch (74), to which the RPs (30) and the SPs (40) are connected as well. This network (72) allows them to exchange NMP messages and other data with the MS (70). Preferably, the MS (70) also comprises a remote access for maintenance.

It should be noted that FIG. 4 also applies to the data storage system (20) in FIG. 5, although less connections to the Ethernet switch (74) would be required since the RPs (30) and the SPs (40) are combined in pairs. In the embodiment of FIG. 6, the MS (70) communicates with the RPs (30) and the SPs (40) using the data network (10). The data network (10) is then used to propagate the changes to the configuration database in each device of the data storage system (20).

As aforesaid, the main function of the MS (70) is to maintain and update a configuration database whenever this is required. One aspect of the configuration database is the assignment of containers to the SPs (40). Each SP (40) knows at all time which logical container or containers it handles. Accordingly, any request concerning a data object stored or to be stored in one of the SUs (60) must transit through the SP (40) handling the logical container where the data object is located. This assignment is explained further in the text.

Once the system initialization is complete, the MS (70) starts operating using an initial configuration database. In use, the configuration may change as a result of an intervention from an operator or through reconfiguration triggered as a result of a failure or discovery of node available for use in the data storage system (20). For instance, if a SP (40) becomes inoperative, the logical container or containers that were previously assigned to the failed SP will have to be re-assigned to one or more other SPs (40). This is done by mapping the label of the logical container in the configuration database with a different SP address. The changes in the configuration database are then propagated through the control network (72), or through the data network (10) in the embodiment of FIG. 6, so that each RP (30) will know which SP (40) to contact for a given logical container and each SP (40) will know which logical containers it has to handle.

Once the SP (40) becomes operative again, the SP (40) preferably sends a corresponding message to the MS (70), which may then eventually reconfigure the data storage system (20) back to the previous settings. The discovery of newly available RPs (30) or SPs (40) can be achieved by broadcasting a corresponding message to the MS (70). If one of such nodes is discovered, the MS (70) may register the node and assign an identification number to it. For example, if the MS (70) discovers a new RP, it may assign to this new RP an identification number, for instance RP3.

The MS (70) can also be used to test various topology configurations and select the one being the most successful, if it is programmed to do so. Furthermore, the MS (70) may include a routine to periodically check the status of the RPs (30) and the SPs (40) in order to detect if one of them goes out of service. For instance, each RP (30) and SP (40) may be programmed to periodically transmit a heartbeat message to the MS (70). Therefore, one indication of component failure will be the occurrence of a timeout failure on the expected heartbeat message. Problems with SPs (40) may also be reported to the MS (70) by one of the RPs (30) if it detects that a SP (40) failed to respond in a timely fashion or outputs erratic results. Conversely, a SP (40) may report that one the RPs (30) is out of service if it failed to acknowledge response to a message, in the cases where such procedure is implemented. A client (12) may otherwise inform a RP (30) that another RP (30) is out of service.

I/O Routing at the RPs

The I/O routing is implemented in the daemon provided in each RP (30). Whenever a new data object is to be stored in the storage pool, it must first be determined in which logical container it will be located. This is preferably achieved using a hashing scheme, i.e. a sorting technique, based on the computation of a mapping between one or more attributes of a data object and the unique identifying label of a logical container that is the target for storing the new data object. The attribute or attributes of the new data object can be any convenient one, such as:
the full path name;
the location descriptor;
the location device (at the SU);
the dates (creation date, last edit date, etc.);
the file type;
the size of the data object;
etc.

Although there are many possible attributes that can be used, the attribute or attributes chosen in the hashing scheme do not change while the data storage system (20) is in use.

The computational procedure employed takes as input the binary representation of the data object attribute or attributes. Using a series of mathematical operations applied to the input, it outputs a label or produces a list of labels that identifies the destination containers for the new data object. The label of the destination container can be any string of binary digits that uniquely identifies the destination container for the data object to be stored. The length of the returned list is configurable according to specific implementation requirements but the minimum list length is one container label.

The computational procedure applied to the binary representation of the data attributes employs a series of binary operations that have the effect of scattering, in a statistically substantially uniform fashion, the resulting listed labels in a statistically substantially-uniform distribution over the storage pool. The specifics of the algorithm used are determined by the particular implementation of the data storage system (20). For instance, the final choice of the destination container within a list is carried out by applying the binary modulus operation to the listed labels with respect to the number of configured containers for a particular data storage system. This operation essentially computes the remainder of a binary division operation. This remainder is the binary representation of a positive integer number that identifies the destination container for the new data object.

One possible and preferable way of calculating the destination container is to use a cyclic redundancy check (CRC) algorithm, for instance the CRC-32 algorithm. The CRC-32 algorithm may be applied to the ASCII string of the full path name and a 32-bit checksum number would be generated therefrom. Applying a mask to the resulting number allows to obtain a random number within the desired range. The mask may be, for instance, 5 bits in length for a data storage system (20) having 32 containers (2⁵=32). Of course, other methods of generating a random number can be used as well, for instance the CRC-16 algorithm or any other kind of algorithm. The CRC algorithms are well known in the art of computers as a method of obtaining a checksum number and do not need to be further described.

The following is a simplified example of the calculation of the destination container:

First, the CRC-32 algorithm generates a number. The resulting number can be for instance as follows:

01101100111100111110000110101110

A 5-bit number (for a 32-container implementation) can be obtained from the above number by applying, for instance, the following mask:

00000000000000000000000000011111

The mask is applied using a logical AND operation with the number resulting from the CRC-32 algorithm. The above example ultimately gives the following number:

01110

This number corresponds to 14 (0×2⁴+1×2³+1×2²+1×2¹+0×2⁰) out of containers 0 to 31.

The routing scheme is invoked at least when a new data object is stored for the first time. Subsequently, depending on which attribute or attributes are used, the data objects will need to be found through a hierarchy of data object description sent by the SPs (40) when needed or using the information recorded in a local cache at a corresponding RP (30). However, if a scheme only uses the full name of the data object as the attribute, then entering the full name through the routing scheme will indicate in which logical container the existing data object is stored.

Wait Queue

Preferably, whenever an operation is required on a data object, a record concerning the operation request is created by the routing software in a request queue at the corresponding RP (30). The routing software manages the wait queue for notification of the status of pending operations. It keeps track of a maximum delay for receiving a response to the requested operation. If a requested operation is successfully completed in due course, then the record concerning the operation is removed from the wait queue. However, if the anticipated response is not received in a timely fashion, then the RP (30) preferably executes error recovery procedures. This may include trying the operation again for one or more times. If this does not function either, then the RP (30) will have to send an error message to the client (12) who requested the operation. The RP (30) should also report the error to the MS (70) for further investigation.

Once an operation request is completed, the results are received by the RP (30), which forward them back to the client (12) who requested the operation. This preferably occurs by decoding information on the results of data operations recovered from the wait queue. The client (12) is then either notified that the data objects are available or the results are immediately transferred thereto. Preferably, an internal function is provided so that if several operation requests are issued by a same client (12), the results are sent as a single global result.

Logical Network Names

Preferably, the RPs (30) within a given data storage system (20) appear to clients (12) as virtual named network devices. A processor in a node will be known to other processors within its node, and to processors in other nodes of the data storage system (20), using a logical network name of the form:
network.domain.node.processor

For example, a RP (30) that is part of a data storage system (20) named “Max-T” in the domain named “RND” could have the logical name:

Max-T.RND.router.rp0

The NMP is preferably used to resolve the logical network names used by the internal processors to TCP/IP addresses for the purposes of initialization of the data storage system (20), discovery, configuration and reconfiguration, and to support failure processes. Also, the NMP preferably supports discovery of the node configuration and provide routing information to clients (12) that need to connect to a node to access node services. Also, the RPs (30) should support access security controls covering access authorization and node identification.

Similarly, the SPs (40) are assigned logical network names that identify the RPs (30) and other nodes. For example, a typical SP (40) would have a name such as:

Max-T.RND.storage.sp3

The processors of a SP (40) run a Daemon that implements the NMP. The Daemon is responsible for the maintenance of required configuration information. The NMP negotiation is preferably used to resolve this name into a TCP/IP address that will be used by other nodes to establish connections to the SPs (40). RPs (30) to SPs (40) communications are then established based on the logical names. When reconfiguration occurs due to failure or discovery, the logical network name is mapped to a new TCP/IP address.

The relationship between a specific SP and its logical network name is managed by the configuration process. SP configuration preferably involves the following steps:
acquisition of a TCP/IP address on the local node network using DHCP;
use of the NMP to get a logical network name and a list of file systems to mount;
mount the specified file systems and broadcast an NMP message supporting discovery of the processor by other nodes; and
use of the NMP messages to update its configuration database.

When powered up or reconfigured, SPs (40) preferably broadcasts their presence to the configured network domain so that any nodes currently in the data storage system (20) can query the node for its configuration. The SPs (40) then respond to discovery queries from other network nodes.

The SPs (40) manage a storage pool configured as a collection of file systems on the attached storage arrays that are designated as part of the storage pool. The SPs (40) can also process requests to any other storage pool, such as a legacy storage pool that someone wants to connect to the data storage system (20), such as shown in FIG. 6. While the storage pool is managed to provide features related to scalability and performance, legacy storage pools and other file systems not forming part of the storage pool will not derive the same benefits.

File System Daemon Design

Preferably, the RPs (30) are running a file system Daemon and a set of standard file system services. The RPs (30) can also run other file systems, such as local disk file systems. Processors in the RPs (30) preferably implement the NMP. The configuration process for a RP (30) then involves the following steps:
use of the DHCP to acquire a TCP/IP address from the NMS;
use of the NMP to get a logical network name;
use of the NMP to broadcast discovery queries to the data storage system (20) to build a copy of its local configuration database; and
use of the NMP to resolve the TCP/IP addresses of the SPs (40) that it will use to route requests.

When powered up or reconfigured, the RPs (30) preferably broadcast a message to the network domain to discover the existence and configuration of SPs (40) in the data storage system (20). The RPs (30) then adjust their routing algorithms according to the state of the configuration database for the data storage system (20) and according to the configuration options thereof.

The file system daemon is to be implemented as one end of a multiplexed full duplex block link driver using a finite state machine based design. The file system daemon is preferably designed to support sufficient information in its protocol to implement node routing, performance and load management statistics, diagnostic features for problem identification and isolation, and the management of conditions originating outside of the nodes, such as client related timeouts, link failures and client system error recoveries.

The communications functions between the file system and the corresponding daemon are implemented via a virtual communication layer based on the standard socket paradigm. The virtual communication layer is implemented as a library used by both the file system and the corresponding daemon. Within the library, specific transport protocols, such as TCP and VI, can be transparently replaced according to technological developments without altering either the file system code or the daemon code.

Operation of the Data Storage System

One of the advantages of the data storage system (20) is that it allows to produce a unified view of all data objects within the data storage system (20), upon request. Each SP (40) is responsible for transmitting to a RP (30) a list of data objects and some of its attributes within a particular directory. Because a given directory may have data objects in any logical containers, every SP (40) must formulate a response with a list of data objects or subdirectories within a given directory. The client (12) from which the request for a list of data objects originated will receive a directory list similar to any conventional file system. Means are provided to ensure that all clients (12) see correct and current attributes for all data objects being managed thereby. These means are provided to collect the attribute information for all data objects into a single, unified hierarchy of data object description. The data object attributes are independent of the presentation or activity on any node of the data storage system (20). Each RP (30) may also maintain a local cache of data objects recently listed in directories. The cache is employed to reduce the overhead of revalidation of the current view of data object attributes delivered to a client (12). The data in the cache advantageously comprises the container label associated with each data object recently listed in a directory.

Advantageously, the attributes of data objects are mapped to an identifier which provides a unique means of identifying the location of a data object, or portion thereof, within the storage pool. This consequently allows to recover the attributes of data objects. It also allows to construct, using the attributes of a portion of a data object, a data structure that uniquely identifies the sub-portion of the data object. It then encodes the description in a format suitable for transmission over the system. A suite of software tools is also provided for the recovery of the attributes at the receiving end.

Whenever a data object is accessed, the lock management is achieved by the SP (40) which is responsible for the logical container where the data object is located. The lock management is thus distributed among all SPs (40) instead of being achieved by a single node, such as in the case of most SAN systems.

When a client (12) communicates with a RP (30), it must also communicate the required operation. For instance, if a client (12) requests that a new data object be saved, the data object itself is sent along with a message indicated that a “create” command is requested. This message is then sent with the data object itself and an attribute or attributes, such as its file name. Operations on existing data objects within the storage pool may include, without limitation:
read (or view);
open;
save (or create);
rename (or move);
copy;
delete;
search;
etc.

These operation requests are preferably expressed as function identifiers. The function identifiers describe operations on either the data objects and/or on the attribute of the data objects. There is thus a mapping between a list of I/O operations available for data objects and the function identifiers. Furthermore, the nature of the operations to be performed depend on allowable classes of actions. For instance, some clients (12) may be allowed full access to certain data objects while others are not authorize to access them.

The requests for operations on data objects are preferably formatted by the RPs (30) before they are transmitted to the SPs (40). They are preferably encoded to simplify the transmission thereof. The encoding includes the requested operations to be performed on the data object or objects, the routing information on the source and destination of the requested operation, the status information about the requested operation, the performance management information about the requested operation, and the contents and attributes of the data objects on which the operations are to be performed.

Configuration Database Daemon

The MS (70) runs a Configuration Database Daemon (CDBD), which daemon is an application that manages the contents of the configuration database. The configuration database is preferably implemented as a standard flat file keyed database that contains records that hold information about:
the default configuration (release configuration) of the data storage system (20);
the current configuration of the data storage system (20);
statistics on the operation and performance of the data storage system (20)
resource records; and
database Access API Functions.

The CDBD is preferably the only component of the MS software suite that has access to the database file(s). All functional components of the MS (70) preferably gain access to the contents of the database through a standard set of function calls that implement the following API:
int ReadCDB(void *who,const char *key,void *buf,int length); and
int WriteCDB(void *who,const char *key,void *buf,int length);

where the parameters have the following meanings:

| | |
|---|---|
| void *who | A pointer to a block of information that may contain |
| | channel information |
| const char *key | A pointer to a key string that identifies the record to be |
| | processed |
| void *buf | A pointer to a buffer that contains the information to be |
| | written or received the information read |
| int limit | The size of the data buffer |

The API function calls can return a status value that report on the result of the API function call. The minimal set of values that are to be implemented are:

| | |
|---|---|
| OK | The function was successful |
| ERROR | The function was not successful |

The value of OK is a non-zero positive number, while the value of ERROR is a non-zero negative number. For convenience, on success the ReadCBD function may return the number of bytes actually read into the data buffer, while the WriteCDB function may return the number of bytes actually written. Error may be implemented as a series of negative values that identify the type of error detected.

The keys used in the configuration database file are preferably formatted in plain text and having a hierarchical structure. These keys should reflect the contents of the database records. A possible key format is a series of sub-strings separated with, for instance, a period (.). Configuration records may use keys such as:
rp0.default.configuration
rp1.default.configuration
sp1.default.configuration
sp2.default.configuration
rp0.current.configuration
system.default.configuration
etc.

It should be noted that the contents of the configuration database records are preferably XML encoded data that encapsulate the configuration data of the components.

One purpose of the CDBD is to ensure database consistency in the face of possibly simultaneous access by multiple client processes. The CDBD ensures database consistency by serializing access requests, either by requiring nodes to acquire a lock, implementing a permission scheme, or by staging client's requests through a request queue. Because of the likelihood that multiple processes will be submitting client requests asynchronously, the use of a spin lock strategy coupled with blocking API calls should be the most direct solution to the implementation problem.

Implementation of a spin lock strategy requires the following additional API calls:
CDBLock GetCDBLock(const char *type,const char *key)
void FreeCDBLock(CDBLock lock)
where the type parameter is a string that describes the type of access that a node wants. The access types can be “r”, “w” and “rw” for existing records, and “c” for new records. Any number of clients (12) can obtain a read lock (“r”) providing that there is no open write (“w” or “w”) lock on the record(s) in question. Where a create (“c”) lock is granted, it is exclusive to the requester as long as it is opened.

The key parameter is preferably a string describing the key of the database record for which a lock is to be acquired. If this parameter is NULL, then a lock on the entire database is to be acquired. The key parameter can be a specification or a list that can be used to generate a lock on a set of records in the database. For example, the call “CDBLock lock=GetCDBLock(“*.default.*”)” may be used to obtain a lock on all records with keys that contain the component “default”. A token returned is of type CDBLock. This is an opaque handle that can be used subsequently to release the lock with the FreeCDBLock function.

The MS (70) also runs a MS Daemon. The MS Daemon is a process that is responsible for the overall management of the data storage system (20). In particular, the MS Daemon is responsible for management of the state of the finite state machine that implements the data storage system (20). The MS Daemon monitors the status of the machine (node) and responds to the state of the meta-machine by dispatching functions that respond to operating conditions with the goal of bringing the data storage system (20) to the current target state.

The meta-machine is a finite state machine that preferably implements the following list of states:
BOOT—The initial power on state of data storage system (20);
CONFIGURE—The state during which system's components are configured;
RUN—The state of the data storage system (20) when it is configured and running;
ERROR—The state of the machine while an error condition is being handled;
SHUTDOWN—The state of the machine when it is being shut down;
MAINTENANCE—The state of the machine while maintenance operations are under way;
STOP—The state of the machine when only the MS (70) is running; and
RESTART—The state of the machine when restarting.

Within each of the states of the meta-machine, the are provided means to control the operation of the data storage system (20) and move them between meta-machine states. The meta-code for the meta-machine preferably has the following generic form:

{
BOOL Exit = FALSE;
while (!Exit) {
Exit = CheckMachineState( );
}

The function CheckMachineState may implement a dispatch table based on the current meta-machine state. For each meta-machine state, the meta-machine state handler preferably carries out the following tasks:
check the configuration database records relevant to the meta-machine state and determine the status of the data storage system (20) in the current meta-machine state;
initiate, according to the state machine for the meta-machine state, the functions needed to advance the state of the machine;
update the configuration database according to the results of the dispatched functions;
when appropriate, as determined by the state of the machine for the current meta-machine state, update the state of the meta-machine; and
return a status code to indicate whether the master loop should terminate.

The BOOT State

When components are powered on, they all enter meta-machine state BOOT. The MS (70) preferably does the following when in the BOOT state:
starts the CDBD;
initializes the records of the current configuration in the database to show that all components are in an unknown state;
starts up the NMP Daemon;
starts a timer for use in timing out the BOOT state;
handles any NMP_MSG_IDENT messages from the system's components;
if and when all configured components complete the IDENT process (heartbeat message), sets the state of the meta-machine to CONFIGURE and returns a status of 0; and
if an error occurs or the BOOT state times out, sets the meta-machine state to ERROR, posts an error data block in the configuration database, and returns 0.

The NMP Daemon runs on the MS (70) and is the focus of system initialization, system configuration, system control and the management of error recovery procedures that handle any conditions that may occur during the operation of the data storage system (20).

The CONFIGURE State

The CONFIGURE state can be entered either when all components of the data storage system (20) have completed their IDENT processing, or when a transition from an ERROR or RESTART state occurs. The MS (70) will then preferably perform the following functions based on the status of components in the configuration database:
Emit FS_ASSOC messages to the running components;
Emit FS_CK messages to the running components; and
Emit FS_MNT messages to the running components.

Errors in any of the above processes that can be recovered should be handled by the state machine for the CONFIGURE meta-machine state. Errors that can not be recovered should result in the posting of an error status in the configuration database and a transition of the meta-machine to the ERROR state. If the functions of the CONFIGURE state are successfully carried out, the meta-machine is transitioned to the RUN state.

The RUN State

When in the RUN state, the MS daemon monitors the status of the system and transitions the meta-machine to other states based on either operator input (i.e. MaxMin actions) or status information that results from messages processed by the NMP daemon function dispatcher.

The ERROR State

The ERROR state is entered whenever there is a requirement for the MS (70) to handle an error condition that cannot be handled via some trivial means, such as a retry. Generally speaking the ERROR state gets entered when components of data storage system (20) are not able to function as part of the network, typically because of a hardware or software failure on the part of the component, or a failure of a part of the network infrastructure.

The MS (70) preferably carries out the following actions when in the ERROR state:
notify the operator console that an error requiring reconfiguration or repair is required;
if permitted, modify the current configuration in the configuration database and transition the meta-machine to the CONFIGURE state; and
if not permitted to reconfigure, transition the meta-machine to the MAINTENANCE state.

The SHUTDOWN State

The SHUTDOWN state is used to manage the transition from running states to a state where the data storage system (20) can be powered off. The MS (70) preferably carries out the following actions:
transition all of the components into the SHUTDOWN state;
confirm the release of all file systems by the components; and
transition the MS (70) to the STOP state.

The RESTART State

The RESTART state is preferably used to restart the data storage system (20) without cycling the power on the component boxes. The RESTART state can be entered from the ERROR state or the MAINTENANCE state. The responsibilities of the MS (70) in the RESTART state are:
shut down client access to the data storage system (20);
release all file systems; and
transition system into the CONFIGURE state, if successful, or the ERROR state if a failure is detected.

The MAINTENANCE State

The MAINTENANCE state is preferably used to block the creation of new data objects while still allowing access to existing data objects. This state may result from an SP (40) being lost (dead). Operator intervention is then required by the MS (70).

The STOP State

The STOP state is a state where the MS (70) terminates its own components in an orderly fashion and then returns an exit status of 1. This will cause the MS daemon to terminate.

Logging

A log facility is preferably implemented which logs the following information:
all meta-machine state transitions;
all error conditions;
all failures of function library processes;
client component IDENT requests and the results of IDENT processing; and
file associations and modifications thereof.

Software Package Management and Implementation

One suitable platform for support of the software suite allowing to create and manage the data storage system (20) is the Intel based hardware platform with the Linux operating system. Preferably, the kernel-based modules in the software are implemented using ANSI Standard C. User space modules will be implemented using ANSI Standard C or C++ as supported by the GNU compiler. Script based functionality is implemented using either the Python or the PERL scripting language. Moreover, the software for implementing a data storage system (20) is preferably packaged using the standard Red Hat Package Management mechanism for Linux binary releases. Aside from support scripts, no source modules will be distributed as part of the product distribution, unless so required, by issues related to the general public license (GPL) of Linux.

### Conclusion

As can be appreciated, the data storage system (20) and underlying method allow to store and retrieve multiple data objects simultaneously, without the requirement for a centralized global file locking, thus vastly improving the throughput as a whole over previously existing technologies. There is no metadata controller (MDC) which would normally be required as in a SAN system. Instead, each of the SPs (40) is given the responsibility to serving up the contents of particular sections of the storage pool made available by the plurality of SUs (60). Thus, no central point is required to prevent more than one SP (40) from accessing a given data object.

As aforesaid, although preferred and possible embodiments of the invention have been described in detail herein and illustrated in the accompanying figures, it is to be understood that the invention is not limited to these precise embodiments and that various changes and modifications may be effected therein without departing from the scope or spirit of the present invention.

1. A method of processing operation requests related to data objects in a data storage system connected to a multi-client network, the data storage system comprising a storage pool having a plurality of storage units (SUs), the method comprising:
providing at least one routing processor (RP) and a plurality of storage processor (SPs) coupled to the RP and the SUs;
dividing the storage pool into logical containers and assigning each logical container to one of the SPs;
at the RP, receiving an operation request related to a data object from a client of the network;
determining which one of the containers corresponds to the data object;
sending the operation request to the SP assigned to the corresponding logical container;
receiving the operation request at the assigned SP; and
processing the operation request at the SP.

2. A method according to claim 1, wherein the method comprises:
sending the data object with the corresponding requested operation.

3. A method according to claim 1, further comprising:
providing a management station (MS) interconnected to the RP and each SP;
monitoring the operation of at least each SP; and
in case of a failure of one of the SPs, reassigning logical containers of the failed SP to at least one of the other SPs.

4. A method according to claim 3, wherein the act of reassigning logical containers comprises:
updating a configuration database provided in the RP and each SP to reflect new logical container assignations.

5. A method according to claim 1, further comprising:
sending data objects between the SPs and the SUs through a high-speed switch.

6. A method according to claim 5, wherein the high-speed switch is a Fiberchannel switch.

7. A method according to claim 1, further comprising:
verifying at the RP if the operation request is successfully completed within a maximum delay; and
sending a corresponding notification to the client.

8. A method of processing operation requests associated with data objects in a data storage system connected to a multi-client network, the data storage system comprising a storage pool having a plurality of storage units (SUs) divided into logical containers, each logical containers being assigned to one among a plurality of storage processors (SPs), the method comprising:
receiving at a routing processor (RP) a save request from a client of the network concerning a new data object;
determining, from at least one attribute of the new data object, a destination container among the logical containers for storing the new data object;
sending the new data object to the SP to which the selected container is assigned;
receiving the new data object at the SP handling the destination container; and
storing the new data object in the storage pool at the destination container.

9. A method according to claim 8, further comprising:
sending data indicative of a result of the save request to the client from which it originates.

10. A method according to claim 8, wherein the destination container is selected using a scheme carrying out a statistically substantially-uniform distribution of new data objects among containers, the scheme outputting a number corresponding to the destination container in which the new data object is to be stored.

11. A method according to claim 10, wherein the scheme comprises a convolution algorithm.

12. A method according to claim 11, wherein the convolution algorithm comprises the act of generating a number using a Cyclic redundancy check (CRC) algorithm and applying a mask thereto.

13. A method according to claim 8, further comprising:
sending the new data object between the SP and one of the SUs of the storage pool through a high-speed switch.

14. A method according to claim 13, wherein the high-speed switch is a Fiberchannel switch.

15. A method of routing new data objects in a data storage system connected to a multi-client network, the data storage system having a storage pool divided in a predetermined number of logical containers in which data objects are stored, each data object including contents and at least one attribute, the method comprising:
selecting one of the logical containers as a destination container to store a new data object received from a client of the network, the destination container being selected using a scheme providing a statistically substantially uniform distribution of the data objects between the logical containers using at least one attribute of each data object; and
sending the new data object to the destination container.

16. A method according to claim 15, further comprising:
verifying at the RP if the new data object is successfully stored in the destination container within a maximum delay; and
sending a corresponding notification to the client.

17. A data storage system for storing data objects, the data storage system being connected to a multi-client network and being provided with a storage pool having a plurality of storage units (SUs), the system comprising:
at least one routing processor (RP) coupled to the network;
a plurality of storage processors (SPs) coupled to the RP;
a storage pool having a plurality of storage units (SUs), the storage pool being divided into logical containers;
a switch to interconnectivity couple the SPs and the SUs; and
a managing station (MS) coupled to the RP and the SPs, the MS maintaining a main configuration database and corresponding configuration databases in the RP and the SPs to indicate which of the SPs is being assigned to each logical container.

18. A data storage system according to claim 17, wherein the MS is coupled to the RP and the SPs by an independent control network.

19. A data storage system according to claim 17, wherein the switch is a Fiberchannel switch.

20. A data storage system according to claim 17, wherein more than one RP is provided, each of the RPs being coupled to the SPs by a router.

21. A data storage system according to claim 17, wherein each RP comprises:
means for verifying if an operation request concerning a data object is successfully completed within a maximum delay; and
means for sending a corresponding notification to a client of the network from which the operation request originated.

22. A data storage system according to claim 17, wherein each RP comprises:
means for selecting one of the logical containers as a destination container to store a new data object, the means using a scheme providing a statistically substantially-uniform distribution of the data objects between the containers from at least one attribute of each data object.

23. A data storage system according to claim 22, wherein means for selecting one of the logical containers as a destination container comprises:
means for generating a number using a Cyclic redundancy check (CRC) algorithm; and
means for applying a mask to obtain a number indicative of the destination container.
